(19) United States
(12) Patent Application Publication
(10) Pub. No.: US 2017/0277664 A1
(43) Pub. Date: Sep. 28, 2017

(54) GRAPHICAL DATA PRESENTED IN CODE EDITOR ALONG WITH CODE

(71) Applicant: Microsoft Technology Licensing, LLC, Redmond, WA (US)

(72) Inventors: Bogdan Ionut Mihalcea, Bothell, WA (US); Ion Todirel, Bellevue, WA (US)

(21) Appl. No.: 15/137,829

(22) Filed: Apr. 25, 2016

Related U.S. Application Data
(60) Provisional application No. 62/312,125, filed on Mar. 23, 2016.

(51) Int. Cl. G06F 17/22; G06F 3/0484; G06F 3/0481; G06F 17/24; G06F 17/21

(52) U.S. Cl. CPC G06F 17/2235; G06F 17/2252; G06F 17/24; G06F 17/218; G06F 3/0481; G06F 3/0484

(57) ABSTRACT

Methods, systems, apparatuses, and computer program products are provided for enabling graphical information to be presented in program code open in a code editor. A graphics tag is detected in the program code loaded for editing and displayed in a code editor window. A graphical object indication that indicates a graphical object is determined in the code in association with the graphics tag. A graphical object is retrieved from a location indicated by the graphical object indication. The graphical object is displayed in the code editor window at a position corresponding to the graphics tag in the code.

### CROSS REFERENCE TO RELATED APPLICATIONS

This application claims the benefit of U.S. Provisional Application No. 62/312,125, filed on Mar. 23, 2016, titled “Graphical Data Presented In Code Editor Along With Code,” which is incorporated by reference herein in its entirety.

### BACKGROUND

Various types of software development applications exist that software developers may use to develop software. An integrated development environment (IDE) is a type of software development application that contains several development tools in one package. An IDE may include tools such as a source code editor (“code editor”), a build automation tool, and a debugger. Examples of IDEs include Eclipse™ developed by Eclipse Foundation of Ottawa, Canada, ActiveState Komodo™ developed by ActiveState of Vancouver, Canada, IntelliJ IDEA developed by JetBrains of the Czech Republic, Oracle JDeveloper™ developed by Oracle Corporation of Redwood City, Calif., NetBeans developed by Oracle Corporation, Codenvy™ developed by Codenvy of San Francisco, Calif., Xcode® developed by Apple Corporation of Cupertino, Calif., and Microsoft® Visual Studio®, developed by Microsoft Corporation of Redmond, Wash.

Developers frequently have difficulty understanding complex algorithms expressed in program code, such as timing code that interfaces with a sensor, statistical distributions, cryptography algorithms, etc. In their attempts to understand complex algorithms, developers typically are forced to leave the code editor to go another application (e.g., a web browser, offline documentation viewers, books, etc.) that provides explanatory information.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer program products are provided for enabling graphical information to be presented in program code open in a code editor. A graphics tag is detected in the program code loaded for editing and displayed in a code editor window. A graphical object indication that indicates a graphical object is determined in the code in association with the graphics tag. A graphical object is retrieved from a location indicated by the graphical object indication. The graphical object is displayed in the code editor window at a position corresponding to the graphics tag in the code.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a computing device that contains a code editor configured to enable graphical information to be rendered in program code open in the code editor, according to an example embodiment.

FIG. 2 shows a flowchart providing a process in a code editor for rendering graphical information, according to an example embodiment.

FIG. 3 shows a block diagram of a graphics display enabling engine, according to an example embodiment.

FIG. 4 shows a process for adjusting code lines in a code editor window to make room for display of graphical information, according to an example embodiment.

FIG. 5 shows a block diagram of a computing device that includes a code editor window displaying program code, including a graphics tag and an associated graphical object indication that enable display of a graphical object, according to an example embodiment.

FIG. 6 shows a block diagram of the computing device of FIG. 5, where the code editor window displays a graphical object generated based on the graphics tag and associated graphical object indication included in the displayed program code, according to an example embodiment.

FIG. 7 shows a process for enabling a code editor to render graphical information in a code editor window, according to an example embodiment.

FIG. 8 shows a block diagram of code editor program code in which a graphics display enabling engine code block is inserted, according to an example embodiment.

FIG. 9 shows a block diagram of a code editor interfaced with a graphics display enabling engine, according to an example embodiment.

FIG. 10 shows a block diagram of a computing device that includes a code development system that enables graphical information to be displayed in a code editor, according to an example embodiment.

FIG. 11 shows a block diagram of an example computing device that may be used to implement embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments for Graphical Information Displayed in Program Code

Developers frequently have difficulty understanding complex algorithms expressed in program code, such as timing code that interfaces with a sensor, statistical distributions, cryptography algorithms, etc. In their attempts to understand the complex algorithms, developers typically have to leave the code editor to go another application (e.g., a web browser, offline documentation viewers, books, etc.) that provides explanatory information. Documenting program code using complex visual cues (e.g., images, diagrams, videos, etc.) displayed within the program code itself is not conventionally possible. This because conventional code editors are only capable of displaying alphanumeric characters and character-size symbols (e.g., a hash symbol, an ampersand, arrows, a caret or other symbol used to indicate collapsed code, etc.), and are not capable of displaying graphic images or videos. When leaving the code editor to read an information source, it can still be very difficult to understand why program code follows a particular sequence of repetitive steps because the information source is apart from the program code, and the developer therefore can have difficulty relating the information source to the program code.

Embodiments enable a developer to add metadata in the program code file that allows the code editor at editing time to display images or any other kind of graphical data in the program code view along with the program code itself, as well as any comments present in the program code, etc. In this manner, the developer does not need to leave the program code to find reference information about the program code. The reference information is provided by graphics displayed directly in the program code itself

For instance, a picture of a developer of the program code may be displayed in the program code to inform others as to who wrote the program code. In another example timing diagrams or oscilloscope trace snapshots may be displayed within program code for a particular sensor to show a developer why setting pins up and/or down and spinning x microsecs is needed.

Accordingly, a developer (programmer) is enabled to display graphical objects within program code, in particular, displaying the graphical objects within a code editor window used by the developer to edit the code. Conventional code editors only operate in a text mode, and cannot render images. Embodiments add image rendering capabilities to a code editor. The image rendering capability may be added to a code editor by inserting code with the rendering capability into the code of the code editor, by interfacing image rendering code with the code editor (e.g., via an API, as an add-in module, etc.), or by another manner.

In one example, a developer opens program code in a code editor. The code is displayed as text. To inject an image stored at a location accessible at a link within the program code, the developer inserts the link in the code, and flags it with a tag (e.g., one or a sequence of special characters). Whenever such a tag is found in the program code by the code editor, the code editor retrieves the image at the link associated with the tag, automatically shifts down the textual code lines below the tag location to make room for the image, then displays the image within the program code at the location of the tag. The tag may be removed from the view at the user's option, or may be displayed above, adjacent to, or otherwise in association with the displayed image.

Note that the code editor may have various graphics display modes where graphical images are automatically displayed, graphical images are not displayed, graphical images may be displayed upon interaction by the user, etc. For instance, the modes may include a “display graphics mode on”, where tagged graphical objects are displayed in a code editor window within the program code, and a “display graphics mode off,” where the graphics tag is shown in the program code in the code editor window, but the graphical objects are not displayed in the program code. In another mode, a graphical object may be displayed if the user hovers a pointer over the graphical object, clicks on a displayed symbol, and/or otherwise interacts with the graphical object to cause its display.

A graphical object, as referred to herein, may contain text, but is not entirely text, instead being at least partially a pictorial representation of information. A graphical object can be of any pictorial type, such being or including an image, a video (e.g., a video explaining something, proving a demo, etc.), a diagram (e.g., from a Microsoft Visio file), a formatted spreadsheet table, and/or any other pictorial representation.

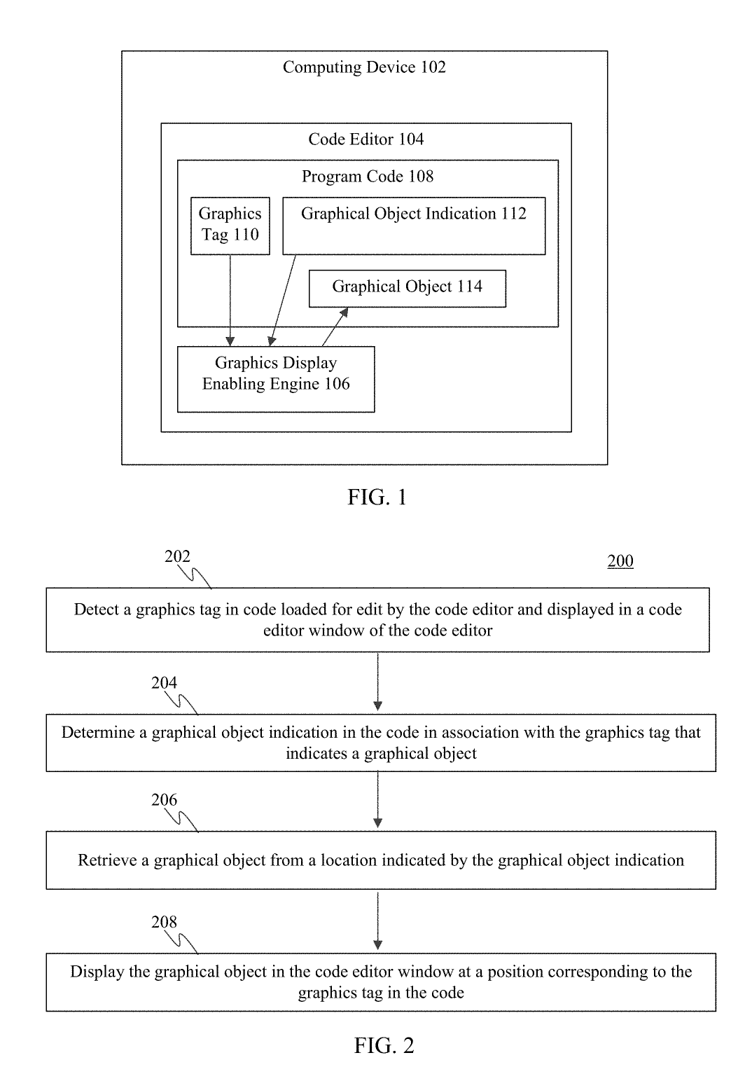

Embodiments may be implemented in various ways. For instance, FIG. 1 shows a block diagram of a computing device 102 that contains a code editor configured to enable graphical information to be rendered in program code open in the code editor, according to an example embodiment. As shown in FIG. 1, computing device 102 includes a code editor 104 and a graphics display enabling engine 106. Code editor 104 displays loaded program code 108, which includes a graphics tag 110 and a graphical object indication 112. FIG. 1 is further described as follows.

Graphics display enabling engine 106 locates graphics tag 110 in program code 108. For example, graphics display enabling engine 106 may be configured to search through program code 108 for a character or string of characters (e.g., alphanumeric characters, symbols, etc.) that define graphics tag 110, according to any suitable search algorithm. After graphics display enabling engine 106 locates graphics tag 110, graphics display enabling engine 106 accesses graphical object indication 112 for an address of a graphical object, obtains the graphical object located at the address indicated by graphical object indication 112 (e.g., in storage of computing device 102, at a remote server over a network, etc.), and displays the obtained graphical object as graphical object 114 within the displayed program code 108. In an embodiment, graphics display enabling engine 106 displays graphical object 114 in program code 108 at a position (e.g., a line) of graphics tag 110 and graphical object indication 112 in program code 108, though in other embodiments, graphics display enabling engine 106 may display graphical object 114 in a different position in program code 108 (e.g., at a default position, at a position indicated in graphical object indication 112, etc.).

Code editor 104 may be any proprietary or conventional code editor configured for editing of program code mentioned elsewhere herein or otherwise known (e.g., a code editor of Eclipse™, ActiveState Komodo™, IntelliJ IDEA, Oracle JDeveloper™ NetBeans, Codenvy™, Xcode®, Microsoft® Visual Studio®, etc.). Graphics display enabling engine 106 is included in or interfaced with code editor 104 to enable display of graphical object in code open in code editor 104, as described herein. For example, graphics enabling engine 106 may be an insertable code block (e.g., C# code, C++ code, other .NET Framework compatible code, machine code, etc.), an add-in module, a plug-in module, code configured to interface with an API, or other code capable of insertion in or interfacing with code editor 104.

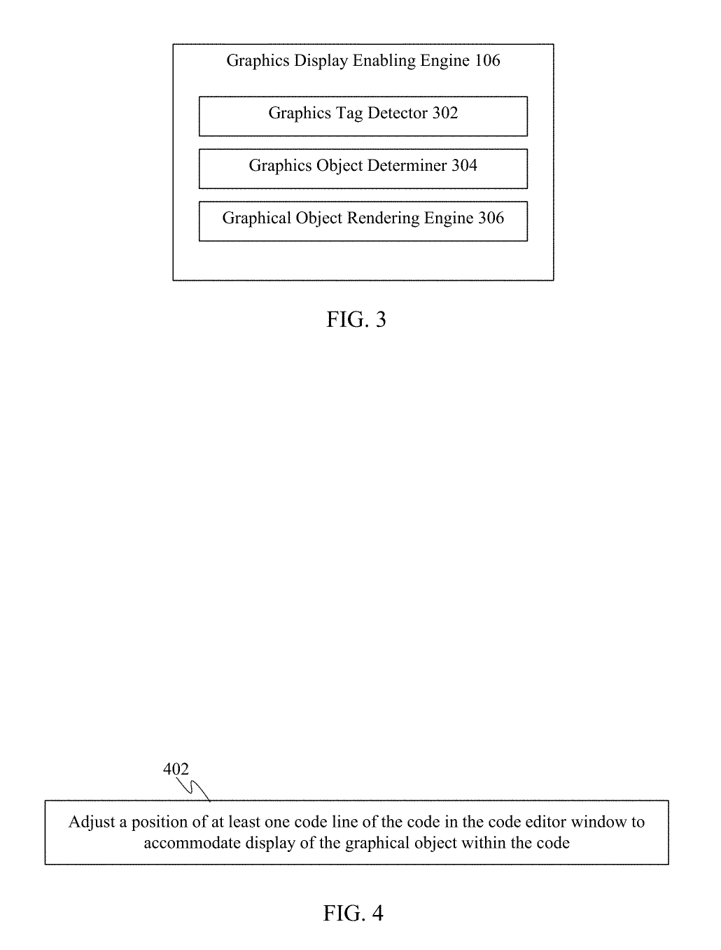

Graphics display enabling engine 106 may be configured in various ways to perform its functions. For instance, FIG. 2 shows a flowchart 200 providing a process in a code editor for rendering graphical information, according to an example embodiment. Graphics display enabling engine 106 may operate according to flowchart 200 in an embodiment. Flowchart 200 is described as follows with reference to FIG. 1 and FIGS. 3-6. FIG. 3 shows a block diagram of graphics display enabling engine 106, according to an example embodiment. As shown in FIG. 3, graphics display enabling engine 106 includes a graphics tag detector 302, a graphics object determiner 304, and a graphical object rendering engine 306.

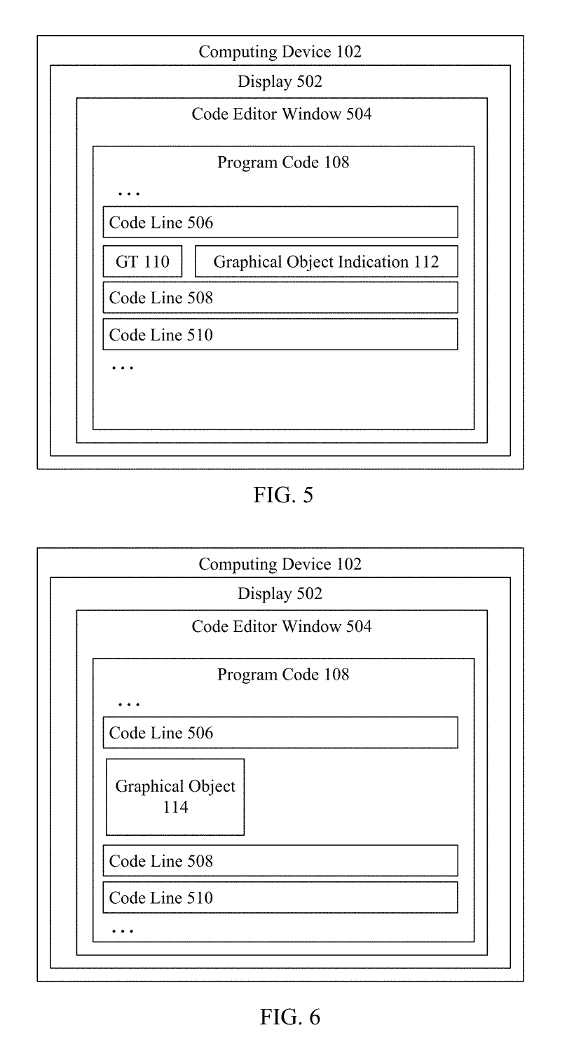

Flowchart 200 begins with step 202. In step 202, a graphics tag is detected in code loaded for edit by the code editor and displayed in a code editor window of the code editor. In an embodiment, graphics tag detector 302 is configured to detect graphics tag 110 in program code 108. FIG. 5 shows a block diagram of computing device 102 having a display 502 that displays a code editor window 504 (e.g., of code editor 104 of FIG. 1) that displays program code 108, including graphics tag (GT) 110 and associated graphical object indication 112, according to an example embodiment. In an embodiment, graphics tag detector 302 detects graphics tag 110 in program code 108 after code line 506, and before code lines 508 and 510.

Display 502 may be any suitable type of display device or screen, including an LCD (liquid crystal display), a CRT (cathode ray tube) display, an LED (light emitting diode) display, a plasma display, etc. Code editor window 504 is a window (framed or frameless) displayed by code editor 104 in display 502 as a graphical user interface (GUI) for interaction with program code 108 displayed in code editor window 504. Code lines 506, 508, and 510 are each one or more lines of code of any suitable programming language, as would be known to persons skilled in the relevant art(s).

In step 204 of flowchart 200, a graphical object indication is determined in the code in association with the graphics tag that indicates a graphical object. In an embodiment, graphics object determiner 304 is configured to determine graphical object indication 112 in association with GT 114 detected by graphics tag detector 302. For instance, in embodiments, graphical object indication 112 may be indicated in text immediately following GT 114, may be indicated in a particular pre-determined format (e.g., between brackets, parenthesis, quotation marks, etc.), or may be indicated in another way that is determinable by graphics object determiner 304. Graphical object indication 112 may indicate an address and/or storage location at computing device 102 (e.g., a file path) or at a remote location (e.g., an HTTP (hypertext transfer protocol) link, etc.). Graphics object determiner 304 is configured to read the address/storage location from graphical object indication 112.

In step 206 of flowchart 200, a graphical object is retrieved from a location indicated by the graphical object indication. In an embodiment, graphics object determiner 304 is configured to retrieve the graphical object at the address/storage location indicated by graphical object indication 112. For example, graphics object determiner 304 may retrieve the graphical object in the form of a file or group of files from storage, may call the graphical object from a remote computing device over a network, or may retrieve the graphical object from any other suitable location.

In step 208 of flowchart 200, the graphical object is displayed in the code editor window at a position corresponding to the graphics tag in the code. In an embodiment, graphical object rendering engine 306 is configured to render the graphical object obtained by graphics object determiner 304 in program code 108 at a position corresponding to GT 114. For instance, FIG. 6 shows computing device 102 of FIG. 5, where code editor window 504 displays graphical object 114 at the position in which GT 110 and associated graphical object indication 112 were located in program code 108 in FIG. 5, according to an example embodiment. In other embodiments, graphical object rendering engine 306 may display graphical object 114 at a different location, such as a position indicated (e.g., a line number, coordinates, etc.) by graphical object indication 112, a default location, or elsewhere in code editor window 504.

In embodiments, graphical object rendering engine 306 is configured to enable display of graphical objects in code editors. For instance, graphical object rendering engine 306 may include a proprietary or commercially available image viewer, a rendering engine similar to a web browser, or other component capable of displaying graphical images and/or videos. Techniques for displaying images are well known to persons skilled in the relevant art(s), including reading image/video files for image/video data (e.g., file formats of JPEG, GIF, BMP, PNG, MPEG, H.265, etc.), interpreting the data, and generating display of an image or video based thereon. Examples of commercially available applications having image viewing capability that may be incorporated in graphical object rendering engine 306 include Microsoft Windows® Photo Viewer™, ACDSee™ by ACD Systems of Seattle Wash., and FastStone Image Viewer™ by FastStone Soft, etc. Examples of commercially available applications having video viewing capability that may be incorporated in graphical object rendering engine 306 include QuickTime® Player by Apple Inc. of Cupertino, Calif., Microsoft® Windows Media® Player, Banshee by Novell Inc. of Provo, Utah, etc.

In the example of FIGS. 5 and 6, code lines of program code 108 are moved to make space for display of graphical object 114. For instance, FIG. 4 shows a step 402 for adjusting code lines in a code editor window to make room for display of graphical information, according to an example embodiment. In step 402, a position of at least one code line of the code in the code editor window is adjusted to accommodate display of the graphical object within the code. For example, as shown in FIG. 6 relative to FIG. 5, code lines 508 and 510 are shifted downward by an amount proportional to the determined height of graphical object 114 to enable graphical object 114 to be displayed at a location of GT 110 and graphical object indication 112 between code lines 506 and 508 (e.g., in place of one or more lines of program code 108) or elsewhere in program code 108.

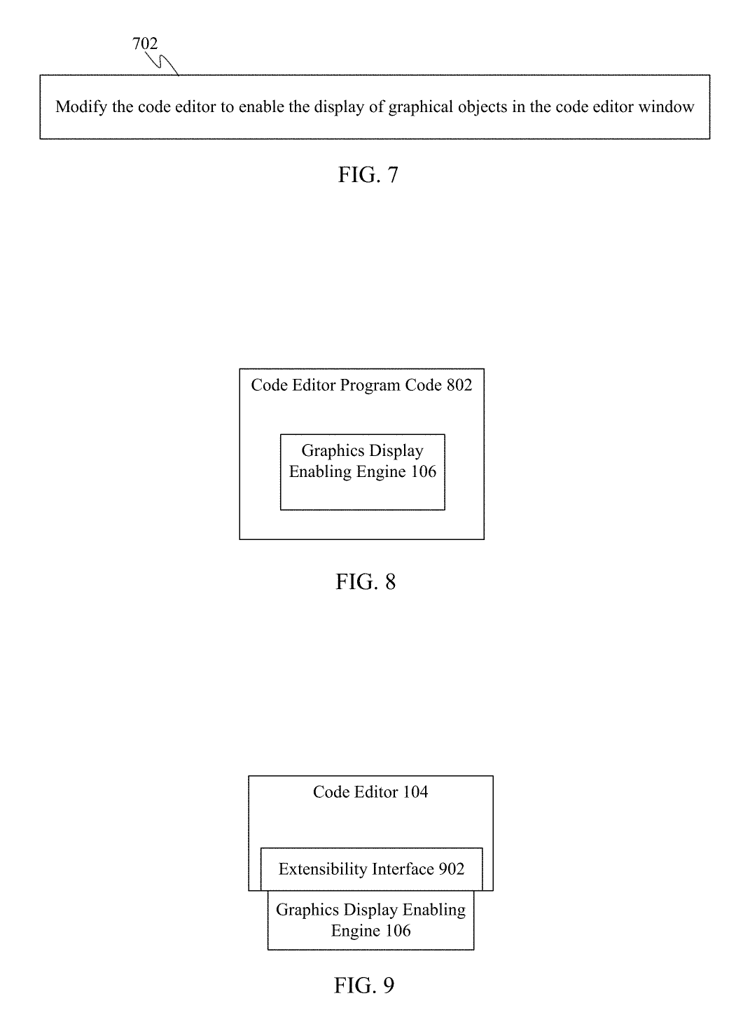

FIG. 7 shows a step 702 for enabling a code editor to render graphical information in a code editor window, according to an example embodiment. In step 702, the code editor is modified to enable the display of graphical objects in the code editor window. In embodiments, code editor 104, which may have been a text editor prior to receiving graphics display enabling engine 106 to provide graphical display capability, may be modified to enable the display of graphical objects in code editor window 504 (FIGS. 5 and 6). FIGS. 8 and 9 show exemplary embodiments for modifying code editor 104 to display graphical objects.

For instance, FIG. 8 shows a block diagram of code editor program code 802 (program code of the application of code editor 104) in which graphics display enabling engine 106 (e.g., program code defining graphics display enabling engine 106) is inserted, according to an example embodiment. By inserting graphics display enabling engine 106 in code editor program code 802, graphics display enabling engine 106 may perform flowchart 200 (FIG. 2) for code editor program code 802 to detect a graphics tag 110 in program code 108, determine the corresponding graphical object indication 112, retrieve a graphical object 114, and provide display instructions for displaying graphical object 114 in program code 108 in code editor window 504 (FIGS. 5 and 6).

FIG. 9 shows a block diagram of code editor 104 interfaced with graphics display enabling engine 106 via an extensibility interface 902 of code editor 104, according to an example embodiment. For example, extensibility interface 902 may provide an interface (e.g., an application programming interface (API), etc.) that enables graphics display enabling engine 106 to interface with code editor 104 as an add-on, plug-in, or in any other manner. Through extensibility interface 902, graphics display enabling engine 106 may perform flowchart 200 (FIG. 2) via communications with code editor 104, such as detecting a graphics tag 110 in program code 108, determining the corresponding graphical object indication 112, retrieving a graphical object 114, and providing display instructions to code editor 104 and graphics capability for displaying graphical object 114 in program code 108 in code editor window 504 (FIGS. 5 and 6).

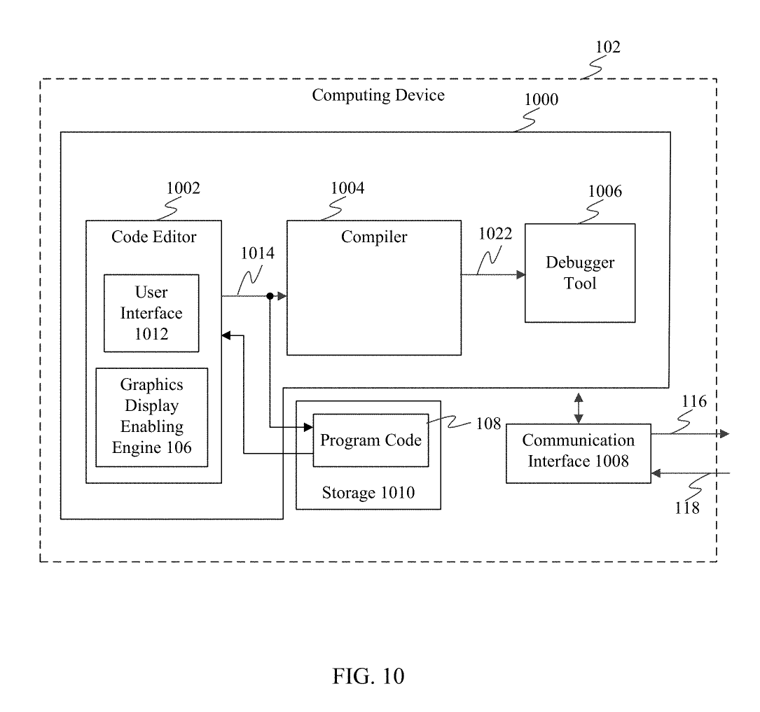

Development systems may be configured in various ways to develop source code, in embodiments. Such development systems may include code editors configured for display of graphical objects in program code, according to embodiments. For instance, FIG. 10 shows computing device 102 including a development application 1000, storage 1010, and a communication interface 1008. Storage 1010 stores program code 108. Development application 1000 includes a source code editor 1002, a compiler 1004, and a debugger tool 1006. Code editor 1002 includes a user interface 1012 and graphics display enabling engine 106. Note that development application 1000 is provided for illustrative purposes, and as an example embodiment, and not all features of development application 1000 need to be present in all embodiments. Furthermore, additional features not shown in FIG. 10 may be present in some embodiments. The features of system 1000 shown in FIG. 10 are described as follows.

As shown in FIG. 10, development application 1000 may be implemented in one or more computing devices 102. For instance, source code editor 1002, compiler 1004, and debugger tool 1006 may be included in a same computing device, or one or more of source code editor 1002, compiler 1004, and debugger tool 1006 may be implemented in one or more computing devices separate from those of others of source code editor 1002, compiler 1004, and debugger tool 1006.

Computing device 102 may be one or more of any type of stationary or mobile computing device(s), including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer).

A developer may interact with source code editor 1002 to enter and modify program code when generating source code for an application. For instance, the developer may interact with a user interface 1012 of code editor 1002 to add, modify, or delete program code text such as by typing, by voice input, by selecting suggested code blocks, etc. Accordingly, user interface 1012 may include one or more text entry boxes/windows (e.g., code editor window 504 of FIG. 5), voice/speech recognition, one or more graphical user interface elements (e.g., buttons, check boxes, radio buttons, pull down menus, etc.), and/or other user interface elements that a developer may interact with. When complete, or at other intervals, the user may be enabled to save the program code by interacting with a “save” button or other user interface element.

For instance, as shown in FIG. 10, a developer may interact with user interface 1012 of source code editor 1002 to generate program code 108. Program code 108 is source code, which is a collection of computer instructions (possibly with comments) written using a human-readable computer programming language. Examples of suitable human-readable computer programming languages include C, C++, Java, etc. Program code 108 may be received in one or more files or other form. For instance, program code 108 may be received as one or more “.c” files (when the C programming language is used), as one or more “.cpp” files (when the C++ programming language is used), etc. As shown in FIG. 10, program code 108 may be stored in storage 1010. Storage 1010 may include one or more of any type of physical storage hardware/circuitry to store data, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of physical storage hardware/circuitry.

Note that program code 108 may include code statements and/or marked code put into program code 108 as debug code for purposes of debugging (e.g., break points, display of register values, comments, etc.).

Compiler 1004 may be invoked in any manner, such as by a command line, a graphical user interface, etc. A “-full” switch, or other switch, may be used when compiler 1004 is invoked to perform a full compile. Compiler 1004 is configured to receive and compile program code 108 to generate machine code 1022. In particular, compiler 1004 is configured to transform program code 108 into machine code 1022 in the form of another computer language, typically having a binary form, referred to as machine code or object code. In some cases, compiler 1004 may include multiple stages, and may first convert program code 108 into an intermediate form (e.g., an intermediate language), which is subsequently converted into machine code 1022.

Compiler 1004 may be configured to perform one or more types of optimizations on program code 108 when generating machine code 1022. An optimized build results in machine code that is semantically equivalent to machine code generated without optimizations, but is configured in a way that fewer resources are used during execution of the optimized machine code (e.g., less memory, fewer procedure calls, etc.). Examples of optimizations that may be performed include loop optimizations, data-flow optimizations, SSA-based optimizations, code-generator optimizations, functional language optimizations, interprocedural optimizations, and/or further types of optimizations that would be known to persons skilled in the relevant art(s). Many specific types of optimizations exist. For example, “inlining” may be performed, where a callee function called by a caller function is copied into the body of the caller function. In another example of a specific optimization, “common subexpression elimination” may be performed, where a single instance of code is used for a quantity that is computed multiple times in source code.

Machine code 1022 may be included in a file (e.g., an object or “.obj” file), or may be created/stored in another form, to form an executable program or application. Machine code 1022 may optionally be stored in storage 1010.

When program code 108 is compiled by compiler 1004 for the debug stage of development, debugger tool 1006 may receive machine code 1022. Debugger tool 1006 is configured to run a debugger (or “debug”, “debugging”) session on the application represented by machine code 1022. In a debugger session, a developer may be enabled to step through the execution of code of machine code 1022, while viewing the values of variables, arrays, attributes, and/or outputs (e.g., contents of registers, a GUI, etc.) generated by the execution of machine code 1022, including having access to the effects of any debug code/statements entered into program code 108 (and passed to machine code 1022 by compiler 1004 for purposes of debug). In this manner, a developer may be able to test or troubleshoot (“debug”) program code 108, making edits to program code 108 using code editor 1002 based on the results of the debugger session. The modified version of program code 108 may be compiled by compiler 1004 and received by debugger tool 1006 for further debugging. Debugger tool 1006 may include one or more processors (e.g., a central processing unit (CPU)), physical and/or virtual, that execute(s) machine code 1022.

When debugging by debugger tool 1006 is complete, and program code 108 is in its final version, compiler 1004 may compile program code 108 to generate machine code 1022 for the release stage of development. The release version of machine code 1022 may be released to be used by users. Note that when compiling program code 108 to generate machine code 1022 for release, any statements in program code 108 marked as debug statements are ignored (are not compiled so that their compiled versions are not present in machine code 1022).

A developer may design program code 108 to include one or more graphics tags 110 with associated graphical object indications 112, as shown in FIG. 1. In this manner, when program code 108 is displayed in a code editor window, graphics display enabling engine 106 causes the graphical object(s) indicated by graphical object indication(s) 112 to be displayed within program code 108 in the code editor window, in addition to or in place of the graphics tag(s) and graphical object indications.

Furthermore, as described above, development application 106 may be configured to communicate with one or more remote entities (e.g., computing devices such as servers, etc.) to retrieve graphical objects at remote addresses indicated by graphical object indications 112. For example, as shown in FIG. 10, graphics display enabling engine 106 may provide an address determined from a graphical object indication 112 (e.g., a link) to communication interface 1008, and communication interface 1008 may transmit a request 116 (e.g., an HTTP request message) to request the a graphical object from the address at a remote entity. Communication interface 1008 may receive a response 118 (e.g., an HTTP response message) that includes the requested graphical object, and may provide the graphical object to graphics display enabling engine 106 for display in a code editor window (e.g., code editor window 504 of FIG. 5). In an embodiment, communication interface 1008 is configured to communicate with remote entities according to any suitable communication protocol, proprietary or conventional. Further examples of communication interfaces and communication protocols are described in the next section.

### III. Example Mobile and Stationary Device Embodiments

Computing device 102, code editor 104, graphics display enabling engine 106, graphics tag detector 302, graphics object determiner 304, graphical object rendering engine 306, extensibility interface 902, development application 1000, source code editor 1002, compiler 1004, debugger tool 1006, flowchart 200, step 402, and step 702, may be implemented in hardware, or hardware combined with software and/or firmware. For example, code editor 104, graphics display enabling engine 106, graphics tag detector 302, graphics object determiner 304, graphical object rendering engine 306, extensibility interface 902, development application 1000, source code editor 1002, compiler 1004, debugger tool 1006, flowchart 200, step 402, and/or step 702 may be implemented as computer program code/instructions configured to be executed in one or more processors and stored in a computer readable storage medium. Alternatively, computing device 102, code editor 104, graphics display enabling engine 106, graphics tag detector 302, graphics object determiner 304, graphical object rendering engine 306, extensibility interface 902, development application 1000, source code editor 1002, compiler 1004, debugger tool 1006, flowchart 200, step 402, and/or step 702 may be implemented as hardware logic/electrical circuitry.

For instance, in an embodiment, one or more, in any combination, of code editor 104, graphics display enabling engine 106, graphics tag detector 302, graphics object determiner 304, graphical object rendering engine 306, extensibility interface 902, development application 1000, source code editor 1002, compiler 1004, debugger tool 1006, flowchart 200, step 402, and/or step 702 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

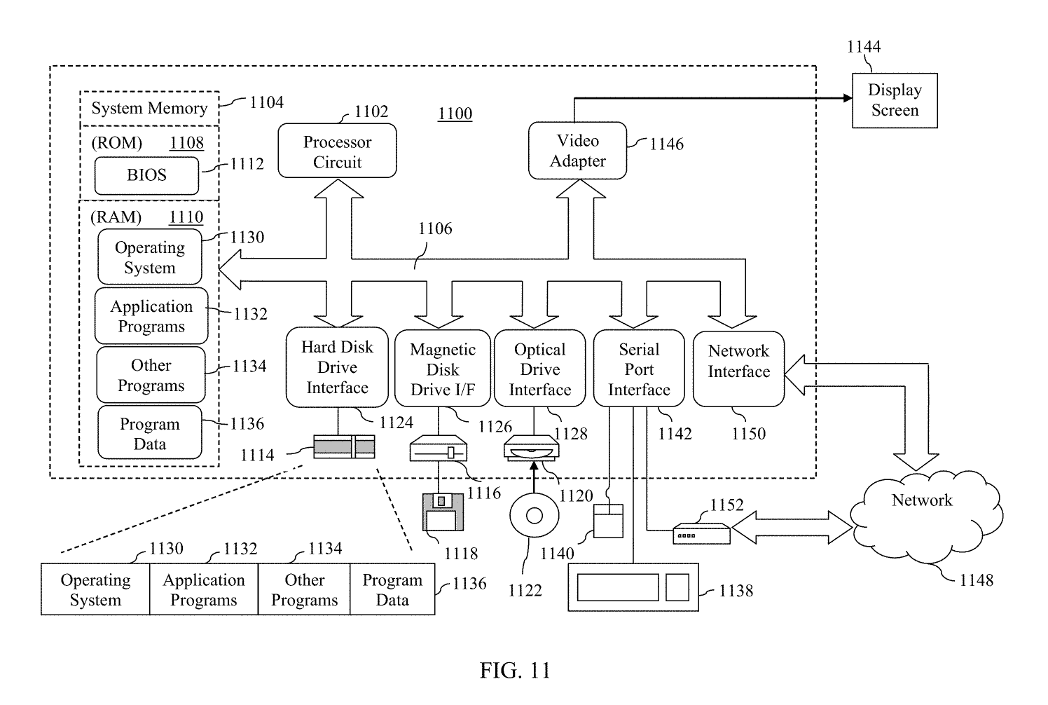

FIG. 11 depicts an exemplary implementation of a computing device 1100 in which embodiments may be implemented. For example, computing device 102 and/or client computing device 104 may be implemented in one or more computing devices similar to computing device 1100 in stationary or mobile computer embodiments, including one or more features of computing device 1100 and/or alternative features. The description of computing device 1100 provided herein is provided for purposes of illustration, and is not intended to be limiting. Embodiments may be implemented in further types of computer systems, as would be known to persons skilled in the relevant art(s).

As shown in FIG. 11, computing device 1100 includes one or more processors, referred to as processor circuit 1102, a system memory 1104, and a bus 1106 that couples various system components including system memory 1104 to processor circuit 1102. Processor circuit 1102 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1102 may execute program code stored in a computer readable medium, such as program code of operating system 1130, application programs 1132, other programs 1134, etc. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random access memory (RAM) 1110. A basic input/output system 1112 (BIOS) is stored in ROM 1108.

Computing device 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1130, one or more application programs 1132, other programs 1134, and program data 1136. Application programs 1132 or other programs 1134 may include, for example, computer program logic (e.g., computer program code or instructions) for implementing code editor 104, graphics display enabling engine 106, graphics tag detector 302, graphics object determiner 304, graphical object rendering engine 306, extensibility interface 1102, development application 1000, source code editor 1002, compiler 1004, debugger tool 1006, flowchart 200, step 402, and/or step 702 (including any suitable step of flowchart 200), and/or further embodiments described herein.

A user may enter commands and information into the computing device 1100 through input devices such as keyboard 1138 and pointing device 1140. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1102 through a serial port interface 1142 that is coupled to bus 1106, but may be connected by other interfaces, such as a parallel port, game port, or a universal serial bus (USB).

A display screen 1144 is also connected to bus 1106 via an interface, such as a video adapter 1146. Display screen 1144 may be external to, or incorporated in computing device 1100. Display screen 1144 may display information, as well as being a user interface for receiving user commands and/or other information (e.g., by touch, finger gestures, virtual keyboard, etc.). In addition to display screen 1144, computing device 1100 may include other peripheral output devices (not shown) such as speakers and printers.

Computing device 1100 is connected to a network 1148 (e.g., the Internet) through an adaptor or network interface 1150, a modem 1152, or other means for establishing communications over the network. Modem 1152, which may be internal or external, may be connected to bus 1106 via serial port interface 1142, as shown in FIG. 11, or may be connected to bus 1106 using another interface type, including a parallel interface.

As used herein, the terms “computer program medium,” “computer-readable medium,” and “computer-readable storage medium” are used to refer to physical hardware media such as the hard disk associated with hard disk drive 1114, removable magnetic disk 1118, removable optical disk 1122, other physical hardware media such as RAMs, ROMs, flash memory cards, digital video disks, zip disks, MEMs, nanotechnology-based storage devices, and further types of physical/tangible hardware storage media (including memory 1220 of FIG. 12). Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1132 and other programs 1134) may be stored on the hard disk, magnetic disk, optical disk, ROM, RAM, or other hardware storage medium. Such computer programs may also be received via network interface 1150, serial port interface 1142, or any other interface type. Such computer programs, when executed or loaded by an application, enable computing device 1100 to implement features of embodiments discussed herein. Accordingly, such computer programs represent controllers of the computing device 1100.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### VI. Example Embodiments

In an embodiment, a method in a code editor comprises: detecting a graphics tag in code loaded for edit by the code editor and displayed in a code editor window of the code editor; determining a graphical object indication in the code in association with the graphics tag; retrieving a graphical object from a location indicated by the graphical object indication; and displaying the graphical object in the code editor window at a position corresponding to the graphics tag in the code.

In an embodiment, the displaying comprises: adjusting a position of at least one code line of the code in the code editor window to accommodate display of the graphical object within the code.

In an embodiment, the method further comprises: modifying the code editor to enable the display of graphical objects in the code editor window.

In an embodiment, the modifying comprises: inserting a graphics display enabling engine in program code that implements the code editor.

In an embodiment, the modifying comprises: coupling a graphics display enabling engine with an interface of the code editor.

In an embodiment, the displaying comprises: rendering the graphical object in the code editor window automatically upon completion of said retrieving.

In an embodiment, the displaying comprises: rendering the graphical object in the code editor window upon detection of an interaction with the code editor window.

In an embodiment, the graphical object comprises at least one of an image, a video, a spreadsheet table, or a flowchart.

In another embodiment, a computing device comprises: at least one processor circuit; and at least one memory that stores program code configured to be executed by the at least one processor circuit, the program code configured to perform acts comprising: detecting a graphics tag in code loaded for edit by the code editor and displayed in a code editor window of the code editor; determining a graphical object indication in the code in association with the graphics tag; retrieving a graphical object from a location indicated by the graphical object indication; and displaying the graphical object in the code editor window at a position corresponding to the graphics tag in the code.

In an embodiment, the displaying comprises: adjusting a position of at least one code line of the code in the code editor window to accommodate display of the graphical object within the code.

In an embodiment, the displaying comprises: rendering the graphical object in the code editor window automatically upon completion of said retrieving.

In an embodiment, the displaying comprises: rendering the graphical object in the code editor window upon detection of an interaction with the code editor window.

In an embodiment, the determining comprises: determining a link associated with the graphics tag in the code; and wherein said retrieving comprises: retrieving the graphical object from an address defined by the link.

In an embodiment, the graphical object comprises at least one of an image, a video, a spreadsheet table, or a flowchart.

In another embodiment, a computer readable storage medium has computer program instructions embodied in said computer readable storage medium for enabling a processor to display graphics in a code editor, the computer program instructions comprising: a graphics tag detector configured to detect a graphics tag in code loaded for edit by the code editor and displayed in a code editor window of the code editor; a graphics object determiner configured to determine a graphical object indication in the code in association with the graphics tag, and retrieve a graphical object from a location indicated by the graphical object indication; and a graphical object rendering engine configured to display the graphical object in the code editor window at a position corresponding to the graphics tag in the code.

In an embodiment, the graphical object rendering engine is configured to adjust a position of at least one code line of the code in the code editor window to accommodate display of the graphical object within the code.

In an embodiment, the graphical object rendering engine is configured to render the graphical object in the code editor window automatically upon retrieval of the graphical object.

In an embodiment, the graphical object rendering engine is configured to render the graphical object in the code editor window upon detection of an interaction with the code editor window.

In an embodiment, the graphics object determiner is configured to determine a link associated with the graphics tag in the code and retrieve the graphical object from an address defined by the link.

In an embodiment, the graphical object comprises at least one of an image, a video, a spreadsheet table, or a flowchart.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a code editor, comprising:
detecting a graphics tag in code loaded for edit by the code editor and displayed in a code editor window of the code editor;
determining a graphical object indication in the code in association with the graphics tag;
retrieving a graphical object from a location indicated by the graphical object indication; and
displaying the graphical object in the code editor window at a position corresponding to the graphics tag in the code.

2. The method of claim 1, wherein said displaying comprises:
adjusting a position of at least one code line of the code in the code editor window to accommodate display of the graphical object within the code.

3. The method of claim 1, further comprising:
modifying the code editor to enable the display of graphical objects in the code editor window.

4. The method of claim 3, wherein said modifying comprises:
inserting a graphics display enabling engine in program code that implements the code editor.

5. The method of claim 3, wherein said modifying comprises:
coupling a graphics display enabling engine with an interface of the code editor.

6. The method of claim 1, wherein said displaying comprises:
rendering the graphical object in the code editor window automatically upon completion of said retrieving.

7. The method of claim 1, wherein said displaying comprises:
rendering the graphical object in the code editor window upon detection of an interaction with the code editor window.

8. The method of claim 1, wherein the graphical object comprises at least one of an image, a video, a spreadsheet table, or a flowchart.

9. A computing device, comprising:
at least one processor circuit; and
at least one memory that stores program code configured to be executed by the at least one processor circuit, the program code configured to perform acts comprising:
detecting a graphics tag in code loaded for edit by the code editor and displayed in a code editor window of the code editor;
determining a graphical object indication in the code in association with the graphics tag;
retrieving a graphical object from a location indicated by the graphical object indication; and
displaying the graphical object in the code editor window at a position corresponding to the graphics tag in the code.

10. The computing device of claim 9, wherein said displaying comprises:
adjusting a position of at least one code line of the code in the code editor window to accommodate display of the graphical object within the code.

11. The computing device of claim 9, wherein said displaying comprises:
rendering the graphical object in the code editor window automatically upon completion of said retrieving.

12. The computing device of claim 9, wherein said displaying comprises:
rendering the graphical object in the code editor window upon detection of an interaction with the code editor window.

13. The computing device of claim 9, wherein said determining comprises:
determining a link associated with the graphics tag in the code; and wherein said retrieving comprises:
retrieving the graphical object from an address defined by the link.

14. The computing device of claim 9, wherein the graphical object comprises at least one of an image, a video, a spreadsheet table, or a flowchart.

15. A computer readable storage medium having computer program instructions embodied in said computer readable storage medium for enabling a processor to display graphics in a code editor, the computer program instructions comprising:
a graphics tag detector configured to detect a graphics tag in code loaded for edit by the code editor and displayed in a code editor window of the code editor;
a graphics object determiner configured to determine a graphical object indication in the code in association with the graphics tag, and retrieve a graphical object from a location indicated by the graphical object indication; and
a graphical object rendering engine configured to display the graphical object in the code editor window at a position corresponding to the graphics tag in the code.

16. The computer readable storage medium of claim 15, wherein the graphical object rendering engine is configured to adjust a position of at least one code line of the code in the code editor window to accommodate display of the graphical object within the code.

17. The computer readable storage medium of claim 15, wherein the graphical object rendering engine is configured to render the graphical object in the code editor window automatically upon retrieval of the graphical object.

18. The computer readable storage medium of claim 15, wherein the graphical object rendering engine is configured to render the graphical object in the code editor window upon detection of an interaction with the code editor window.

19. The computer readable storage medium of claim 15, wherein the graphics object determiner is configured to determine a link associated with the graphics tag in the code and retrieve the graphical object from an address defined by the link.

20. The computer readable storage medium of claim 15, wherein the graphical object comprises at least one of an image, a video, a spreadsheet table, or a flowchart.
